(19) United States
(12) Patent Application Publication
(10) Pub. No.: US 2026/0093259 A1
(43) Pub. Date: Apr. 2, 2026

(54) Systems and Methods for Maneuver Feedback

(71) Applicant: Universal City Studios LLC, Universal City, CA (US)

(72) Inventors: David G. Majdali, Orlando, FL (US); Gregory Paul Habiak, Orlando, FL (US)

(21) Appl. No.: 18/902,016

(22) Filed: Sep. 30, 2024

(51) Int. Cl. G05D 1/60; B62D 57/032; G05D 1/24; G05D 109/12; G05D 111/30; G05D 111/50; H01Q 1/22

(52) U.S. Cl. CPC G05D 1/60; B62D 57/032; G05D 1/24; H01Q 1/2266; G05D 2109/12; G05D 2111/30; G05D 2111/52

(57) ABSTRACT

A method for performing a robot maneuver includes outputting, via one or more processors of a controller, instructions to at least a robot or an actuating device separate from the robot, wherein the instructions cause the robot to execute a maneuver. The method also includes obtaining, via the one or more processors of the controller, at least position information or orientation information for the robot subsequent to outputting the instructions. Further, the method includes determining, via the one or more processors of the controller, that the maneuver is executed unsuccessfully based on at least the position information or the orientation information. Further still, the method includes adjusting, via the one or more processors of the controller, operation of at least the robot or the actuating device separate from the robot based on the maneuver being executed unsuccessfully.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Themed entertainment areas, including amusement parks, often include interactive areas, including rides and attractions. Some themed entertainment areas include robots (e.g., remotely controlled robots and/or automated robots) that provide an immersive experience for guests of the themed entertainment areas. For example, the robots may perform actions for viewing by the guests. However, ensuring that the robots accurately perform the actions is a complex endeavor.

### BRIEF DESCRIPTION

Certain embodiments commensurate in scope with the originally claimed subject matter are discussed below. These embodiments are not intended to limit the scope of the disclosure. Indeed, the present disclosure may encompass a variety of forms that may be similar to or different from the embodiments set forth below.

In an embodiment, the present disclosure relates to a method for performing a robot maneuver. The method includes outputting, via one or more processors of a controller, instructions to at least a robot or an actuating device separate from the robot, wherein the instructions cause the robot to execute a maneuver. The method also includes obtaining, via the one or more processors of the controller, at least position information or orientation information for the robot subsequent to outputting the instructions. Further, the method includes determining, via the one or more processors of the controller, that the maneuver is executed unsuccessfully based on at least the position information or the orientation information. Further still, the method includes adjusting, via the one or more processors of the controller, operation of at least the robot or the actuating device separate from the robot based on the maneuver being executed unsuccessfully.

In an embodiment, the present disclosure relates to a system for performing a robot maneuver. The system includes a robot body configured to be controlled by one or more actuators. The system also includes a plurality of antennas. Further, the system includes one or more transceivers coupled to the plurality of antennas. Further, the system includes a processing system that includes one or more processors coupled to the one or more transceivers and the one or more actuators, and the processing system is configured to obtain an indication to execute a maneuver via the actuators. The processing system is also configured to determine an action to perform based on the maneuver. Further, the processing system is configured to transmit position information, orientation information, or both. Further still, the processing system is configured to perform the action associated with the maneuver.

In an embodiment, the present disclosure relates to a robot maneuver system. The robot maneuver system includes a processing system having one or more processors. The processing system is configured to transmit instructions to execute a maneuver to a robot within an amusement attraction. The instructions are stored in memory accessible by the processing system. The processing system is also configured to transmit action parameters associated with the maneuver. The processing system is also configured to obtain position information, orientation information, or both, subsequent to transmitting the instructions to execute the maneuver. Further, the processing system is configured to determine updated action parameters based on the position information, the orientation information, or both. Even further, the processing system is configured to adjust operation of the robot based on the updated action parameters.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is schematic diagram of a robot maneuver system for monitoring and adjusting actions performed by robots within an amusement park attraction, in accordance with an aspect of the present disclosure;

FIG. 2 is a block diagram illustrating a robot maneuver system, in accordance with an aspect of the present disclosure;

FIG. 3 is a data flow diagram illustrating a first example of communication between a maneuver robot and a maneuver controller performed in the robot maneuver system of FIG. 1, in accordance with an aspect of the present disclosure;

FIG. 4 is a data flow diagram illustrating a second example of communication between a robot and a maneuver controller performed in the robot maneuver system of FIG. 1, in accordance with aspects of the present disclosure;

FIG. 5 is a schematic diagram illustrating the robot maneuver system of FIG. 1, in accordance with aspects of the present disclosure; and

FIG. 6 is a schematic diagram illustrating the robot maneuver system of FIG. 1 adjusting multiple maneuvers of the robot, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers'specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

As used herein, the “robot” refers to a mechanically actuated figure or animated figure. In some instances, the animated figure may include and/or represent a robot.

As referred to herein, a “maneuver” refers to a desired physical feat that includes performing one or more actions (e.g., jumping, rolling, leaping, running, walking, sliding, turning, and the like) to accomplish or achieve a physical goal (e.g., reach a target height, reach a target location, reach a target speed, reach a target distance from an original location, face a particular direction). As several non-limiting examples, a maneuver may include jumping to a target height, leaping from one location to a target location, running and jumping onto a trampoline to leap to travel a target distance, swinging on a trapeze from one location to another, and the like.

An amusement park attraction may include robots that execute one or more maneuvers to increase the immersive experience of guests, patrons, visitors, or customers within the amusement park attraction. The robot may be autonomous (e.g., the robot performs actions to reach the physical goal without direct input from an operator) or semi-autonomous (e.g., the robot performs actions to execute a maneuver using at least partial input from the operator). For example, the figure may be an animated figure that is pre-programmed to actuate to execute certain maneuvers or that is at least partially controlled by a human operator to execute certain maneuvers. Although described in the context of a robot, it should be noted that the disclosed techniques may also be applied to ride vehicles that execute maneuvers.

The success of the maneuver may be generally related to how accurately the robot reaches the physical goal. Indeed, there may be a degree of error associated with reaching the physical goal. At least in some instances, guests may gain more excitement from maneuvers that include physical goals that are difficult to reach. Failing the physical goal (e.g., being outside of a threshold range of the physical goal) of the maneuver may reduce the immersive experience provided to the guests. Accordingly, it is presently recognized that it may be advantageous to monitor how accurately the robot executes the physical goal and to adjust actions and/or the physical goal to reduce the likelihood of the robot failing to reach the goal in a current attempt and/or subsequent attempts.

The present disclosure relates to a robot maneuver system that provides tracking of kinematic variables (e.g., velocity, speed, position, orientation, acceleration) before, while, and/or after the robot executes a maneuver. As previously noted, a “robot” refers to an autonomous or semi-autonomous animated figure or robot and it may include an onboard processor system (e.g., including one or more processors) and memory (e.g., including one or more memories). In some embodiments, the robot may include a controller (e.g., having a processor and a memory). The disclosed techniques include tracking the kinematic variables of the robot using sensors and/or antennas disposed in one or more positions within a themed entertainment area. As used herein, the “themed entertainment area” may include an amusement park attraction that may include interactive areas, rides, and attractions. For example, the one or more sensors (e.g., position sensors, accelerometers, and the like) and/or antennas may be disposed on (e.g., on one or more surfaces, such as one or more interior surfaces, one or more exterior surfaces, or both) or within the robot (e.g., within the housing of the robot). Additionally or alternatively, the sensors and/or antennas may be disposed in different locations proximate to (e.g., within a threshold area) a target location or area where the maneuver is executed.

The antennas may receive a signal transmitted from an external transceiver (e.g., via an antenna) and a processor may use time-of-flight measurements to determine position information and/or orientation information of the robot, which may indicate whether the robot successfully executed the maneuver. For example, the time-of-flight information may indicate a first timestamp corresponding to transmission of the signals by the transceiver via its antennas and a second timestamp corresponding to receipt of the signals by a transceiver or receiver via its antennas (e.g., a timestamp corresponding to receipt of signals by each robot, a difference in the timestamp corresponding to receipt of the signal, and the like). Based on the determined time-of-flight, the processor may communicate (e.g., via ultra-wideband (UWB) communication) signals that include position information (e.g., three-dimensional Cartesian coordinates, polar coordinates, and the like), orientation information (e.g., a direction that the interactive device is facing, a degree of roll, pitch, and/or yaw of the interactive device), or both, to an external controller (e.g., an environment controller), which may cause the controller to adjust subsequent actions, physical goals and/or maneuvers executed by the robot 14 or other robots 14.

Although the above discussion relates to antennas, it should be noted that position information and/or orientation information may be determined using other suitable detection systems, such as light detection and ranging (LiDAR) systems, light sensors, cameras, position sensors, and the like. In any case, data acquired by sensors and/or antennas may be used to monitor maneuvers executed by the robots and adjust the actions and/or physical goals (e.g., adjust the maneuver) for a current execution and/or subsequent executions of the maneuver.

Although the above description relates to themed entertainment areas, including amusement parks, it should be noted that the above techniques may apply to robots in other locations, such as warehouses, automobiles, robots at home, and so on.

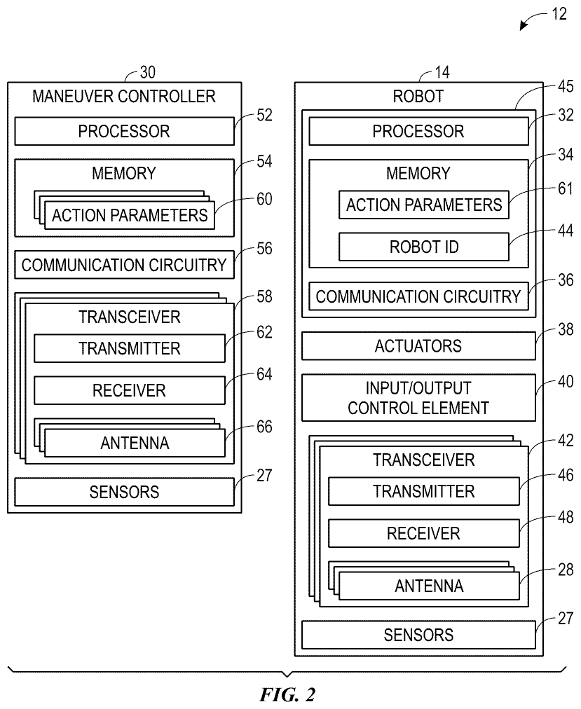

In an embodiment when antennas are used to determine kinematic variables of the robot, the antennas may be used to determine time-of-flight measurements. To determine time-of-flight measurements, the antennas of the robot may be disposed in different locations (e.g., on one or more surfaces, such as one or more interior surfaces, one or more exterior surfaces, or both) of the robot. Each antenna may receive a signal from an external transmitter (e.g., of a maneuver controller as described in more detail in FIG. 2). As such, signals transmitted by the external transceiver may be received by each antenna of the robot at a different time. The different times of signal receipt may be related to a distance between each antenna and the external transceiver, as described in further detail below. This correlation between timing and distance may facilitate evaluation and assessment of outcomes and performance characteristics of maneuvers, in accordance with present embodiments.

In an embodiment of the present disclosure, a maneuver may include a robot leaping or otherwise launching through the air. For example, a robot may bounce off of a trampoline and hang in the air prior to reaching a landing location (e.g., a physical goal). In some embodiments, a processor may operate to cause a transmitter to transmit signals from an antenna proximate to the landing location. A processor of a robot may operate to receive the signals via multiple antennas on the surfaces of the robot. Then, the processor of the robot may determine a time-of-flight of the signals based in part on the time the antennas received the signals. For example, the time-of-flight measurements may indicate a transmission time stamp corresponding to transmission of the signal by the antenna proximate to the landing location and one or more additional time stamps corresponding to receipt of the signals by one or more antennas on the surfaces of the robot.

Based on the determined time-of-flight (e.g., times of signal transmissions and respective times of receipt of the signals at multiple antennas), the known relative positioning of antennas, distance data correlations to transmission timing, and so forth, the processor (which may include one or more processors) of the robot and/or the maneuver controller may determine location data (e.g., location data at one or more instances during or after a maneuver). This location data may include position information (e.g., two-dimensional Cartesian coordinates, three-dimensional Cartesian coordinates, polar coordinates, and the like), orientation information (e.g., a direction the robot is facing), or both. Further, this location data may be communicated (e.g., via ultra-wideband (UWB) communication, ultra-high frequency (UHF) communication, or other communication protocols) via signals that include the position information to the maneuver controller. The processor of the maneuver controller may determine whether the maneuver was executed successfully (e.g., the physical goal is within a threshold range) or in a desired manner (e.g., positional information at various instances combine to provide a desired motion presentation). If the maneuver was not successful (e.g., the physical goal is outside the threshold range), the processor of the maneuver controller may determine an adjustment to one or more actuators (e.g., actuated legs, motor-driven wheels) of the robot to adjust the velocity and/or acceleration of the robot for execution of a subsequent maneuver. Additionally or alternatively, the processor of the maneuver controller may determine that an alternative action or a supplemental action should be performed while executing a current and/or subsequent maneuver to ensure that the maneuver is executed successfully. In this way, the robot maneuver system may improve the likelihood of successful maneuvers subsequently executed by robots, thereby improving the immersive experience of guests within an amusement park.

In some embodiments, the maneuver controller may utilize sensor information to determine the position information and/or orientation information of the robot. For example, the robot may include position sensors that determine a physical location of the robot (e.g., GPS coordinates, polar coordinates, relative coordinates, cartesian coordinates). As such, the maneuver controller may receive position data from the position sensors and determine whether the maneuver was executed successfully (e.g., the physical goal is within a threshold range) or in a desired manner. If the maneuver was not successful (e.g., the physical goal is outside the threshold range), the processor of the maneuver controller may determine an adjustment to one or more actuators (e.g., actuators that control the legs of the robot) to adjust the movement (e.g., velocity, acceleration, orientation) of robot executing a maneuver (e.g., a jump).

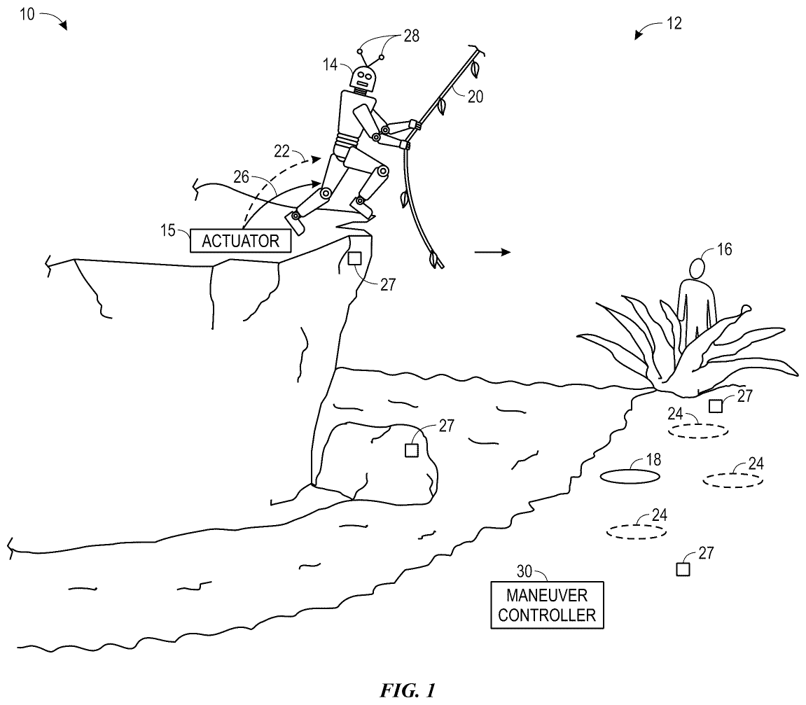

With the foregoing in mind, FIG. 1 shows a perspective view of an amusement park attraction 10 that includes a robot maneuver system 12. The robot maneuver system 12 may cause a robot 14 to perform an action (e.g., jumping, swinging, rolling, leaping, and the like) to execute a maneuver. As referred to herein, a “maneuver” refers to a desired goal to accomplish by way of the action, such as jumping to a target height, swinging to a target location, leaping to target location, rolling a target distance, and the like. While described in terms of distance or displacement, it should be noted that maneuvers may also be described in terms of speed, acceleration, orientation, or force. For example, the maneuvers may include jumping such that the robot 14 accelerates at a target initial acceleration or leaping off a building such that the robot's speed reaches a target speed.

In any case, the robot maneuver system 12 may also monitor data (e.g., position data, orientation data, and the like) to determine whether the maneuver was executed successfully or unsuccessfully. In turn, the robot maneuver system 12 may utilize the data to adjust subsequent attempts at the maneuver by the robot 14 or other robots 14. In this way, the robot maneuver system 12 provides what can be considered closed loop control of actions performed by the robots 14.

In an amusement park context, it may be desirable that the robot 14 executes the maneuvers to entertain one or more guests 16 within or otherwise in view of the amusement park attraction 10. To that end, FIG. 1 shows one example of a maneuver being executed by the robot 14. In the illustrated embodiment, the robot 14 is performing a leap to a target location 18 using an attraction feature 20 (e.g., a vine). In some embodiments, the attraction feature 20 may be a suitable device that may be used for performing an action, such as a diving board or platform for the robot 14 to jump off, a trampoline for the robot 14 to jump on, a trapeze for the robot 14 to swing on, and so on. In some embodiments, the attraction feature 20 may include features that are not used for maneuvers, such as thematic elements of an amusement park attraction 10. However, in some embodiments, the target location 18 may correspond to areas outside of ride vehicles, areas on a ride vehicle, objects within the amusement park attraction (e.g., leaping onto a chair, swinging through an opening), and the like.

As described herein, the robot 14 may be an autonomous or semi-autonomous robot having a controller, such as an animated figure. The controller may include a processor and memory. In some embodiments, the robot 14 may be at least partially controlled by a control system that includes one or more controllers. The robot 14 may include suitable mechanical components for executing the actions to execute the maneuver. In operation, the robot 14 may obtain instructions (e.g., a maneuver instruction) from a maneuver controller indicating a maneuver for the robot 14 to execute. For example, a control system (e.g., a computer, a controller) that may include a processor and a memory of the robot 14 may detect the target location 18 and determine an action to reach the target location 18. In some embodiments, the robot 14 may receive input from a controller (e.g., the maneuver controller) indicating that the robot 14 is to execute the maneuver. That is, an operator may provide an input into an input device, which is communicated to the robot 14. The input may indicate one or more maneuvers to execute, action parameters associated with the maneuvers, a number of maneuvers to execute, a style of an action to execute, or a combination thereof. In some embodiments, the inputs may be provided to a maneuver controller, which communicates the inputs to the robot 14, thereby controlling operation of the robot 14. To execute the maneuver, the robot 14 may obtain action parameters associated with the action that may cause the robot 14 to reach the target location 18 by executing the action in accordance with the action parameters. The action parameters may include forces applied by the actuators, timing instructions, positioning/orientation instructions, and the like that cause the robot 14 to perform the action. For example, the parameters may include an amount of force to apply to one or more actuators of the robot 14 that cause the robot to execute a jump. As another non-limiting example, the action parameters may include a number of steps that the robot 14 should take to reach a target velocity (e.g., before leaping). Accordingly, the robot 14 may execute the maneuver by performing a series of actions.

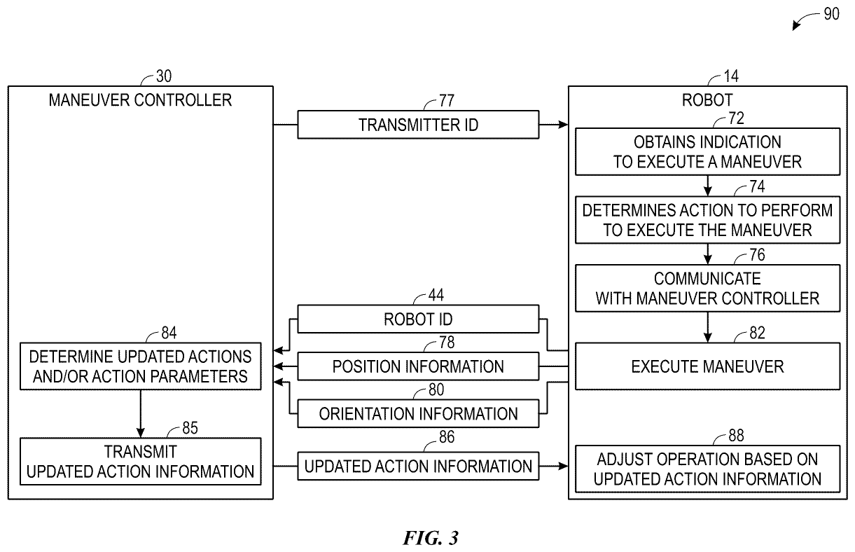

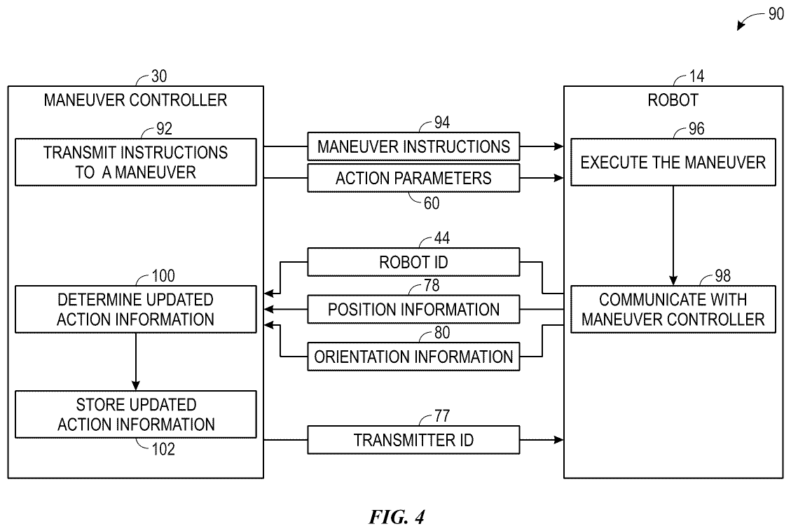

In the illustrated embodiment, the robot 14 has performed a jump and is moving along a trajectory 22. However, at least in some instances, the trajectory 22 of the robot 14 performing the jump may not cause the robot 14 to reach the target location 18, and thus the maneuver will be unsuccessful. Instead, the robot 14 may reach an incorrect target location 24. The illustrated embodiment also includes a corrected trajectory 26 that corresponds to a trajectory that would cause the robot 14 to reach the target location 18, and thus execute the maneuver successfully. Alternatively, the show may require that the robot 14 makes multiple jumps and have multiple corresponding target locations 18. Following each jump, the location and orientation of the robot may be determined. If the robot 14 landed at an incorrect target location 24, then a corrected trajectory 26 may be determined (e.g., calculated) for the next jump. To ensure that the robot 14 executes maneuvers successfully (e.g., reaches the target location 18 by jumping), it is presently recognized that it may be advantageous to utilize one or more sensors 27 and/or antennas 28 that communicate with a maneuver controller 30 and provide positional and/or orientational tracking of the robot 14, which may be used to adjust maneuvers (e.g., actions performed to execute the maneuver), as described in more detail with respect to FIGS. 3 and 4. For example, the sensors 27 may include accelerometers or position sensors that detect the location of the robot 14 during or after executing the maneuver. In this embodiment, the sensors 27 may be disposed within the robot 14. In some embodiments, the sensors 27 may be disposed outside of the robot 14. For example, the sensors 27 may include motion sensors and/or occupancy sensors that detect a signal indicative of the location of the robot 14 (e.g., outside of the target location 18) within the amusement park attraction 10. In some embodiments, the sensors 27 (e.g., disposed external to the robot 14) may include an imaging device or camera capable of recording images of the robot 14. The images may be used to determine whether the robot 14 performed an action in a desired manner. For example, the sensors 27 may acquire multiple images during a time period when the robot 14 is performing a jump. The maneuver controller 30 may analyze the images to determine whether the robot 14 performed the jump in the desired manner (e.g., the desired style of jump).

At least in some instances, the robot 14 may be a “dummy robot” that does not include actuators for performing the action or does not necessarily actuate the actuators to perform the action. Instead, an actuating device 15 that is separate from the robot 14 may include actuators that activate to cause the robot 14 to perform the action. For example, the actuating device 15 may include a catapult, a cannon, a slingshot, a spring, a ramp, a slide with an adjustable ramp, a diving board with one or more springs, and so on. In such embodiments, the actuating device 15 and/or the robot 14 may include the antennas or sensors used to measure kinematic variables discussed herein. In some embodiments, the robot 14 may include actuators to perform certain operations but also be actuated (e.g., launched) from a separate actuating device 15. This may allow for added complexity of operation. For example, the robot 14 may be launched into the air and then on-board actuators of the robot 14 may operate to cause the robot 14 to perform acrobatics in mid-air.

To perform the operations described herein, the robot 14 and the maneuver controller 30 may each include certain processing circuitry (e.g., a processing system including one or more processors), memory circuitry (e.g., one or more memories), and communication circuitry. To illustrate this, FIG. 2 is a block diagram of a robot 14 and a maneuver controller 30. In an embodiment, the one or more robots 14 may each include a processor 32 (representative of one or more processors), a memory 34 (representative of one or more memories), and communication circuitry 36 to enable the one or more robots 14 to communicate with the maneuver controller 30. The various functional blocks shown in FIG. 2 may include hardware elements (including circuitry), software elements (including machine-executable instructions) or a combination of both hardware and software elements (which may be referred to as logic). The processor 32, the memory 34 (e.g., nonvolatile storage), the communication circuitry 36, and/or one or more actuators 38 may each be communicatively coupled directly or indirectly (e.g., through or via another component, a communication bus, a network) to one another to transmit and/or receive data between one another. It should be noted that FIG. 2 is merely one example of a particular implementation and is intended to illustrate the types of components that may be present in the robot 14 and the maneuver controller 30. Although certain descriptions herein may describe that instructions, determinations, and other operations are being executed or performed by controllers, it should be noted that those operations may be performed by processors that may be included in those controllers.

The memory 34 may include one or more tangible, non-transitory, computer-readable media that stores instructions executable by the processor 32 and/or stores data (e.g., action parameters corresponding to one or more maneuvers, a sequence of actions to perform for a maneuver, and so on) to be processed by the processors 32. For example, the memory 34 may include random access memory (RAM), read only memory (ROM), rewritable non-volatile memory such as flash memory, hard drives, optical discs, and/or the like. Additionally, the processor 32 may include one or more general purpose microprocessors, one or more application specific processors (ASICs), one or more field programmable gate arrays (FPGAs), or any combination thereof. Further, the memory 34 may store instructions executable by the processor 32 to perform the methods and control actions described herein.

The robot 14 may also include an input/output control element 40 (e.g., an input device as described herein), which may include a mouse, joystick, control pad, or other selectable features, and other interfacing components that aid a user in controlling at least some of the operations of the robot (e.g., sending a control signal that causes the one or more actuators 38 to operate in a manner that causes the robot 14 to perform a jump). For example, the input/output control element 40 may be capable of receiving an input that controls the robot 14. In some embodiments, the input/output control element 40 may be an offboard control element. For example, the maneuver controller 30 may include the offboard input/output control element 40 (e.g., instead of the robot 14). As such, a user or operator may control the operation of the robot 14 using the maneuver controller 30. In some embodiments, the input/output control element 40 may be offboard from the robot 14 and offboard from the maneuver controller 30.

As discussed above, the input may indicate one or more maneuvers to execute, action parameters associated with the maneuvers, a number of maneuvers to execute, a style of an action to perform, or a combination thereof. In some embodiments, the input/output control element 40 may provide a time stamp measurement to the maneuver controller 30 to track the position and/or orientation of the robot 14, thereby facilitating monitoring of the success of the maneuvers executed by the robot and/or adjusting action parameters used to control the actions performed by the robot 14 (e.g., via the one or more actuators 38). For example, the maneuver controller 30 may transmit a time stamp in addition to the instructions executing a maneuver. The time stamp measurement may be used to determine a time-of-flight measurement. For example, the transmission time stamp corresponding to transmission of the signal by the antenna proximate to the landing location and one or more additional time stamps corresponding to receipt of the signals by one or more antennas on the surfaces of the robot.

The maneuver condition may indicate a velocity (e.g., indicating a velocity of the robot 14 that is running), an acceleration, and a relative position (e.g., indicating a height the robot 14 has jumped). In this way, the maneuver condition may be utilized by the maneuver controller 30 to enable monitoring and/or adjusting of the robot 14 (for example, tracking of the robot 14).

The communication circuitry 36 may include, for example, one or more communication circuitry 36 for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In some embodiments, the communication circuitry 36 may transmit signals indicating data to the maneuver controller 30 via antennas using ultra-wideband (UWB) communication (e.g., at a frequency between 3.1 gigahertz (GHz) to 10.6 GHz), radio frequency identification (RFID) beacons and/or tags (e.g., at approximate frequencies of 433 megahertz (MHz) or 860-960 MHz), or Wi-Fi (e.g., at approximate frequencies of 2.4 GHz or 5 GHz).

In some embodiments, the robot 14 may include an onboard controller 45. As shown, the onboard controller 45 may include the processor 32, the memory 34, and the communication circuitry 36. However, in some embodiments, the onboard controller 45 may not include the communication circuitry 36. As such, the onboard controller 45 may be communicatively coupled to communication circuitry that is external to the onboard controller 45. In some embodiments, the processor 32 and memory 34 could be provided in separate components, as compared to both being packaged together on the onboard controller 45.

As shown, the robot 14 includes a transceiver 42 that includes a transmitter 46 and/or a receiver 48 that support transmission and receipt of various wireless signals via one or more antennas 28. For example, the transceiver 42 may include multiple transmitters 46, multiple receivers 48, and/or multiple antennas 28 as suitable for various communication standards.

In some embodiments, the memory 34 of the robot 14 may store a robot ID 44 that indicates an identity of the robot 14. For example, the robot ID 44 may be an alpha and/or numeric code corresponding to a particular robot 14 that may be used by the maneuver controller 30 to identify the robot 14 when communicating with the robot 14 (e.g., via respective communication circuitry).

The sensors 27 may include accelerometers, occupancy sensors, motion sensors, and the like, that are capable of detecting position information and/or orientation information of the robot 14. In some embodiments, the robot 14 may include a payload. A payload may include appendages, attachments, output devices, end effectors, outside layers, robotic heads, and the like. In some embodiments, the sensors 27 may be disposed on the robot 14 (e.g., on one or more surfaces). For example, the sensors 27 may be disposed on moveable surfaces (e.g., movable payloads, the appendages of the robot 14). Additionally or alternatively, the sensors 27 may be disposed on core surfaces, such as the torso of the robot 14 or a payload of the robot 14, such as outside layers (e.g., removable outside layers and/or non-removable or fixed outside layers) of the robot 14. In some embodiments, the payload may include thematic elements, such as clothing worn on the torso of the robot, or other components. It should be noted that, although the disclosure generally describes using data associated with the antennas 28 (e.g., time-of-flight measurements) to determine the location of the robot 14, at least in some instances, data (e.g., sensor measurements, such as acceleration measurements, position measurements, and the like) acquired by the sensors 27 may be used in addition to the data associated with the antennas 28. In some embodiments, the sensors 27 may be disposed on inner surfaces (e.g., internal surfaces) of the robot 14, which may be hidden to prevent breaking the immersive experience of the guests. For example, the sensors 27 may be disposed under a payload of the robot 14 and/or on an internal surface of an outer layer of the robot 14. In some embodiments, the sensors 27 may include weather sensors capable of detecting weather information (e.g., a wind speed, a presence of precipitation, a wind direction). In some embodiments, the sensors 27 may include temperature sensors capable of detecting a temperature of a power supply of the robot 14 or other surface of the robot 14. In some embodiments, the sensors 27 may include electrical property sensors capable of detecting a battery charge of a power supply (e.g., in an embodiment when the robot 14 is battery powered).

Although the above descriptions relate to the robot 14, it should be noted that the components discussed above (e.g., processors, memory, actuators, communication circuitry, and the like) may be part of an actuating device 15 (FIG. 1) or a controller for an actuating device 15. As described herein, the actuating device 15 may be a device that is separate from the robot 14 and causes the robot 14 to perform the action through operation of the actuating device 15. For example, the actuating device 15 may launch the robot 14 such that the robot appears to perform a jump.

Further, although the descriptions above relate to the robot 14, it should be noted that the components discussed above may be part of a vehicle. As such, the antenna 28 and/or sensors 27 may be disposed on inner and/or outer surfaces of the body of the vehicle.

The maneuver controller 30 may include a processor 52 (representative of one or more processors), a memory 54 (representative of one or more memories), and communication circuitry 56. The memory 54 may include one or more tangible, non-transitory, computer-readable media that store instructions executable by the processor 52 and/or store data (e.g., action parameters corresponding to one or more maneuvers, a sequence of actions to perform for a maneuver, and so on) to be processed by the processors 52. For example, the memory 34 may include random access memory (RAM), read only memory (ROM), rewritable non-volatile memory such as flash memory, hard drives, optical discs, and/or the like. Additionally, the processor 52 may include one or more general purpose microprocessors, one or more application specific processors (ASICs), one or more field programmable gate arrays (FPGAs), or any combination thereof. Further, the memory 54 may store instructions executable by the processor 52 to perform the methods and control actions described herein. For example, a first action parameter 60 may indicate an amount of force to be applied by actuators of the robot 14 to perform a first action of a first maneuver. A second action parameter 60 may indicate an amount of force to be applied by actuators of the robot 14 to perform a second action of a second maneuver.

In some embodiments, the maneuver controller 30 (e.g., the processor 52 of the maneuver controller 30) may perform relatively more processing operations in comparison to the robot 14. For example, the processor 52 may determine when to execute a maneuver, a maneuver for the robot 14 or vehicle to execute, updated one or more actions for one or more subsequent maneuvers, updated action parameters for performing the one or more actions of the one or more subsequent maneuvers, or a combination thereof. It is presently recognized that performing relatively more processing operations on the maneuver controller 30 may reduce a total weight of the robot 14, thereby making it easier for the robot 14 to execute certain maneuvers. Further, performing relatively more processing operations on the maneuver controller 30 may reduce power consumption and/or heat generation of the robot 14, which may improve the performance of the robot 14 (e.g., improving a time period before it may be desirable to charge a battery of the robot, reducing consumption of power that could be used to perform actions, and so on).

In some embodiments, the robot 14 (e.g., the processor 32) may perform at least a portion of the processing operations described above. For example, the processor 32 may determine when to execute a maneuver, a maneuver for the robot 14 or vehicle to execute, updated one or more actions for one or more subsequent maneuvers, updated action parameters for performing the one or more actions of the one or more subsequent maneuvers, or a combination thereof. It is presently recognized that performing at least a portion of the processing operations on the robot 14 may reduce the number of operations performed by the processor 52 of the maneuver controller 30, thereby freeing up computational resources that may be used for other processing operations.

In some embodiments, the memory 34 of the robot 14 may store action parameters 61. Additionally, the maneuver controller 30 may include a transceiver 58 that includes a transmitter 62, a receiver 64, and one or more antennas 66. As described herein, the transceiver 68, the transmitter 62, the receiver 64, and the one or more antennas 66 may be used to determine position information and/or orientation information of the robot 14.

In some embodiments, the robot 14 may perform processing operations, such as determining an action to perform, as opposed to the processing operations being performed off-board the robot 14. For example, the robot 14 may execute a maneuver based on a condition of the robot 14. For example, the robot 14 may execute a maneuver periodically, every thirty minutes, one hour, two hours, three hours, and so on. In some embodiments, the robot 14 may execute the maneuver in response to a trigger event, such as a guest walking by, a guest achieving a high score in an attraction, another robot 14 walking by, and so on. In an embodiment where the robot 14 is a ride vehicle, the robot 14 may execute the maneuver when another robot 14 passes or is within a threshold range of the robot 14. In some embodiments, the robot 14 may execute the maneuver based on a position of the robot 14. For example, the robot 14 may execute the maneuver when it is within a threshold range of a particular feature (e.g., a swing, a ledge, stairs, or other physical features of the amusement park) or confirmed to be communicating with an antenna 66 that corresponds to a particular feature or location within an amusement park.

To illustrate this, FIG. 3 is a data flow diagram of a method 70 for adjusting actions and/or action parameters associated with a maneuver based on an action performed by the robot 14. Certain process blocks performed in the method 70 may be performed by the processor 32 (FIG. 2) of the robot 14 (e.g., or the actuating device 15 (FIG. 1)) and/or the processor 52 (FIG. 2) of the maneuver controller 30 (FIG. 2). However, for simplicity, the actions described below are being described with respect to the robot 14 rather than the processor 32, and the maneuver controller 30 rather than the processor 52. Moreover, certain blocks may be performed in a different order than that illustrated, and indeed, in some embodiments, certain process blocks may be skipped altogether.

As shown in the illustrated embodiment, in process block 72, the robot 14 obtains or receives an indication to execute a maneuver. In some embodiments, the robot 14 may obtain the indication based on input received by a user or operator. For example, an operator may provide an input using the I/O control elements 40 described in FIG. 2. In some embodiments, the robot 14 may obtain the indication when the robot 14 is within a threshold range of a feature in the amusement park. For example, the robot 14 may receive the indication to execute the maneuver when the robot 14 moves within a threshold range of an antenna 66 (FIG. 2), a sensor 27 (FIG. 2), or other device capable of communicating with the robot 14 (e.g., the transceiver 58 of the robot 14). In some embodiments, the robot 14 may execute the maneuver at predetermined time periods. For example, the robot 14 may receive the indication every minute, two minutes, five minutes, thirty minutes, one hour, two hours, and so on. In some embodiments, the robot 14 may receive the indication in response to detecting a trigger event using the sensors 27 disposed on the robot 14 or communicatively coupled to the robot 14.

As shown in the illustrated embodiment, in process block 74, the robot 14 determines one or more actions to perform to execute the maneuver. As described herein, the maneuver generally includes one or more actions for the robot to perform to bring the robot 14 within a desired physical goal. In some embodiments, to determine the action, the robot 14 may access reference information stored in the memory 34 (e.g., as described in FIG. 2) that indicates one or more actions to perform that are associated with the maneuver. For example, the reference information may indicate one or more actions that the processor 32 and/or a user may select. In some embodiments, the reference information may indicate a sequence of actions to perform. For example, the reference information may indicate that running followed by jumping are the actions to perform to execute a maneuver. As described herein, the reference information may indicate the actions to perform to execute the maneuver may be updated based on the success and/or failure of the robot 14 to execute the maneuver. Further, the actions may be updated based on the success and/or failure of the robot 14 to execute the maneuver as described further herein.

At least in some instances, determining the action to perform may also include determining one or more action parameters. The action parameters indicate a magnitude of force to be applied by the actuators and/or target kinematic variables for performing the action. For example, the action parameters may indicate operational parameters of the actuators 38 (FIG. 2) to cause the robot 14 to reach a target velocity. In some embodiments, the action parameters may be stored as reference information in the memory 34 (FIG. 2) of the robot 14. In a similar manner as described with respect to the actions, the action parameters may also be updated based on the success and/or failure of the robot 14 to execute the maneuver as described further herein.

In some embodiments, determining the action (e.g., a current action to perform to execute a current maneuver) may also include obtaining historical information. The historical information may include power information, weather information (e.g., wind-speed, wind-direction, temperature, humidity, precipitation), a number of maneuvers executed by the robot 14, a weight or stress applied to certain components (e.g., a total weight of a payload carried or disposed on the robot 14). As a non-limiting example, the robot 14 may determine a current battery charge of a power supply that powers the robot 14. Then, the robot 14 may determine one or more actions to perform based on the current battery charge of the power supply. For example, the robot 14 may retrieve reference information indicating an amount of power to provide the actuators 38 based on the current battery charge. In this way, the robot 14 may utilize historical information to reduce the likelihood of the robot failing to reach the goal in a current attempt of a maneuver.

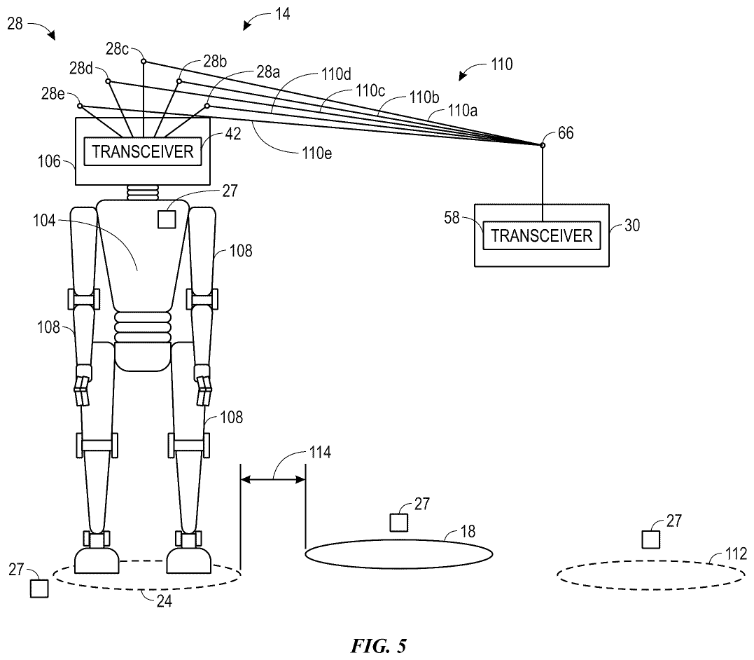

As shown in the illustrated embodiment, in process block 76, the robot 14 communicates with the maneuver controller 30. The robot 14 may receive a transmitter ID 77 from the maneuver controller 30. As described in more detail in FIG. 5, the transmitter ID 77 may include a time stamp that facilitates determination of the position and/or orientation of the robot 14. For example, and as described herein, the robot 14 (e.g., the processor 32 (FIG. 2) of the robot) may determine time-of-flight measurements corresponding to receipt of the transmitter ID 77 by antennas (e.g., antennas 28 of FIGS. 1 and 2) of the robot 14. The robot 14 may communicate position information 78 and/or orientation information 80 to the maneuver controller 30, which facilitates monitoring the success and/or failure of the maneuver. The position information 78 and/or orientation information 80 may indicate a time that the transmitter ID 77 was received by the antenna 28 (FIG. 2) of the robot 14.

The position information 78 may include coordinates (e.g., three-dimensional Cartesian coordinates, two-dimensional Cartesian coordinates, polar coordinates, and the like) or another representation of a position of the robot 14 within a space. The orientation information 80 may include robot orientation information (e.g., relative to the ground or some fixed point). For example, the robot orientation information 80 may indicate whether the robot 14 is upright or not. In some embodiments, the orientation information 80 may include roll, yaw, and/or pitch information, such as data indicating a tilt of the robot 14 (e.g., a degree of inversion or twist of the robot 14 relative to a neutral position as it executes a maneuver). For example, the orientation information 80 may indicate whether the robot 14 remains upright during the attempted execution of the maneuver or whether the robot 14 fell down after attempting the maneuver. The position information 78 and/or orientation information 80 may indicate a time that the transmitter ID 77 was received by the antenna 28 (FIG. 2) of the robot 14. In some embodiments, the robot 14 may communicate a robot ID 44 that indicates a particular robot 14, thereby enabling the maneuver controller 30 to determine the particular robot 14 that is executing the maneuver.

In some embodiments, the robot 14 may transmit the information over a period of time corresponding to executing the maneuver. In some embodiments, the robot 14 transmits the position information 78 and/or orientation information 80 every one second, five seconds, ten seconds, fifteen seconds, thirty seconds, one minute, and so on. In some embodiments, the robot 14 may transmit the information at other frequencies, such as ultra-high frequencies (UHF). For example, the robot 14 may transmit the information at a frequency range between 300 MHz to 3 GHz. It should be noted that the frequency ranges are meant to be non-limiting. In some embodiments, the robot 14 may transmit the information at very high frequencies or lower frequencies.

As shown in the illustrated embodiment, in process block 82, the robot 14 executes the maneuver. As described above, certain blocks of the process 70 may be performed in an order different than what is shown. For example, the robot 14 may communicate the position information 78 and/or orientation information 80 after executing the maneuver. In some embodiments, the robot 14 may transmit the position information 78 and/or orientation information 80 before performing an action associated with the maneuver and after performing the action. For example, in embodiments where the maneuver may include multiple actions, the robot 14 may transmit the position information 78 and/or orientation information 80 before and after each action. In some embodiments, the robot 14 may transmit the position information 78 and/or orientation information 80 before and after executing the maneuver.

At least in some instances, the actuating device 15 (FIG. 1) may cause the robot 14 to perform that action. For example, and as discussed herein, the actuating device 15 may be a catapult that launches the robot 14.

As shown in the illustrated embodiment, in process block 84, the maneuver controller 30 determines updated action information (e.g., updated or additional actions, updated action parameters, or a combination thereof) based on the position information 78 and/or orientation information 80. The maneuver controller 30 may determine the updated actions and/or updated action parameters based on the robot 14 being outside of the target location 18 (FIG. 1).

In some embodiments, the maneuver controller 30 may utilize historical information to determine the updated action information for subsequent maneuvers executed by the robot 14. As discussed herein, the historical information may include power information, weather information (e.g., wind-speed, wind-direction, temperature, humidity, precipitation), a number of maneuvers executed by the robot 14, a weight or stress applied to certain components (e.g., a total weight of a payload carried or disposed on the robot 14). As one non-limiting example, the maneuver controller 30 may receive power information from the robot 14 before the robot 14 executes a maneuver, during the execution of the maneuver by the robot 14, after the robot 14 executes a maneuver, or a combination thereof. The maneuver controller 30 may determine a relationship between the historical information and the maneuver. Continuing with the example above, the relationship may indicate a distance from target location and the power or battery charge and/or battery power output capability of the robot 14. As such, the maneuver controller 30 may determine an updated action parameter to account for the battery charge of the robot 14. For example, the maneuver controller 30 may determine that the robot 14 should provide sufficient power to the actuators 38 (FIG. 2) when the battery charge of the robot 14 is below a threshold battery charge. In some embodiments, the maneuver controller 30 may determine an updated route based on the historical parameters. In this way, the maneuver controller 30 may update the historical information based on the execution of the maneuver by the robot 14 to reduce the likelihood of the robot failing to reach the goal in a subsequent attempt of a maneuver.

As shown in the illustrated embodiment, in process block 85, the maneuver controller 30 transmits the updated action information 86 to the robot 14 (FIG. 1) and/or actuating device 15 (FIG. 1) (e.g., a device separate from the robot 14). Accordingly, the robot 14 and/or the actuating device 15, at block 88, may adjust operation of the robot 14 and/or actuating device 15 based on the updated action information 86. In some embodiments, block 88 may include updating reference information indicating the actions and/or action parameters associated with the maneuver. In this way, during a subsequent execution of the maneuver, the robot 14 may perform different actions and/or the same action(s) with modified (e.g., increased or decreased) action parameters.

Accordingly, the process 70 provides a technique for adjusting operation of autonomous or semi-autonomous robots 14 by adjusting actions and/or action parameters associated with operation of actuators that adjust the movement of the robots 14. In this way, the process 70 may improve the likelihood of success of maneuvers executed by robots 14, thereby improving the immersive experience of guests observing the robots 14.

In some embodiments, the maneuver controller 30 may perform processing operations, such as determining a maneuver to perform, and transmit instructions to the robot 14 to execute the maneuver. To illustrate this, FIG. 4 is a data flow diagram of a method 90 for adjusting actions and/or action parameters associated with a maneuver based on an action performed by the robot 14. Certain process blocks performed in the method 90 may be performed by the processor 32 (FIG. 2) of the robot 14 and/or the processor 52 (FIG. 2) of the maneuver controller 30. However, for simplicity, the actions described below are being described with respect to the robot 14 rather than the processor 32, and the maneuver controller 30 rather than the processor 52. Moreover, certain blocks may be performed in a different order than that illustrated, and indeed, in some embodiments, certain process blocks may be skipped altogether.

As shown in the illustrated embodiment, in block 92, the maneuver controller 30 transmits instructions to execute a maneuver to the robot 14. The maneuver controller 30 may transmit the instructions based on a trigger event and/or based on an input received by an operator (e.g., using the input/output control element 40 as described with reference to FIG. 2). The instructions may include a maneuver instruction 94 that is a signal that indicates a particular type of maneuver to execute. For example, the maneuver instruction 94 may be an alpha and/or numerical string that corresponds to a particular maneuver. At least in some instances, the maneuver instruction 94 may indicate a time period for the robot 14 to execute the maneuver. For example, the maneuver instruction 94 may indicate that the robot 14 should perform an action associated with the maneuver at a particular time or in response to receiving the maneuver instruction 94. In some embodiments, the maneuver instructions 94 may be a trigger event, such as a sensor 27 (FIGS. 1 and 2) detecting a guest walking by, a guest achieving a high score, and the like. In some embodiments, the instructions may be stored in a suitable storage component (e.g., the memory 54 as described with reference to FIG. 2). For example, an operator utilizing the input/output control element 40 (FIG. 2) may provide an input that corresponds to instructions stored in the memory 54 (FIG. 2). Accordingly, the maneuver controller 30 may transmit the instructions to the robot 14.

In some embodiments, the instructions may also include action parameters 60. As described herein, the action parameters 60 may indicate kinematic variables. For example, the action parameters 60 may indicate a magnitude of output (e.g., force, acceleration) to be applied by one or more actuators 38 (FIG. 2) of the robot 14 to perform the action.

In some embodiments, the maneuver controller 30 may transmit the instructions to the actuating device 15 (FIG. 1) (e.g., catapult, incline ramp, zipline, and so on) instead of to the robot 14. As such, one or more actuators of the actuating device 15 may actuate to cause the robot 14 to perform the one or more actions corresponding to the maneuver. In such embodiments, the instructions may also include action parameters 60 corresponding to operating of the actuating device 15, such as an amount of tension in the catapult, a degree of incline in a ramp, an amount of tension in one or more springs of a trampoline, amount of tension in a diving board, and so on.

As shown in the illustrated embodiment, in block 96, the robot 14 executes the maneuver. The robot 14 may execute the maneuver in a generally similar manner as described with respect to block 82 of FIG. 3. Further, at block 98, the robot 14 may communicate the robot ID 44, position information 78, the orientation information 80, or a combination thereof, to the maneuver controller 30. At least in some instances, there may be antenna disposed in suitable locations proximate to where the robot 14 executes maneuvers. For example, referring to FIG. 1, it may be advantageous to position antennas where the robot 14 performs the first action associated with the maneuver and/or within a threshold range of the target location 18 (FIG. 1).

As shown in the illustrated embodiment, at block 100, the maneuver controller 30 determines updated action information (e.g., updated actions and/or updated action parameters) based on the robot ID, position information 78, the orientation information 80, or a combination thereof. The maneuver controller 30 may perform block 100 in a generally similar manner as described with respect to block 84 of FIG. 3. Further, at block 102, the maneuver controller 30 may store the updated action information. Accordingly, the process 90 may be used to optimize action parameters associated with actions performed during maneuvers, to reduce the likelihood of missed maneuvers (e.g., crashes) and/or improve the immersive experience for guests.

The robot 14 may include multiple antennas 28 (FIGS. 1 and 2) and/or sensors 27 (FIGS. 1 and 2) that are capable of detecting the position information 78 and/or the orientation information 80 of the robot 14 based on a time-of-flight measurement. To illustrate this, FIG. 5 shows a schematic diagram of the robot 14 having a transceiver 42 that receives signals 110a, 110b, 110c, 110d, and 110e (e.g., collectively 110) via a respective antenna 28a, 28b, 28c, 28d, and 28e (e.g., collectively 28). The robot 14 includes a robot body 104 that includes payloads (e.g., robot head 106 and robotic appendages 108). The payloads may be controlled by the actuators 38 described in FIG. 2.

The signals 110 may include data such as the transmitter ID 77 (e.g., as described with respect FIGS. 3 and 4) and the signals 110 may be transmitted by the transceiver 58 via the antennas 66 (FIG. 2) of the maneuver controller 30. As described herein, the processor 32 (FIG. 2) of the robot 14 may determine a position and/or orientation of the robot 14 based on respective times that the signals 110 (e.g., the robot ID 44 (FIGS. 3 and 4)) are received by the transceiver 42. That is, the transmitter ID 77 may include a timestamp corresponding to a time when the transmitter ID 77 was sent by the transceiver 58 of the maneuver controller 30. More specifically, each antenna 28 may be disposed at a different location on the robot 14 (e.g., on a top surface of the robot 14, on a bottom surface of the robot 14, on opposing side surfaces of the robot 14, and the like). For example, the antennas 28 may be spaced such that a pitch (e.g., angular tilt) of each of the antennas and/or a spacing between the antennas may be different (e.g., irregular). In such embodiments, the memory 34 of the robot 14 may store pitch information for each antenna 28. The pitch information may indicate a pitch (e.g., an angular tilt relative to longitudinal axis of the robot 14 that runs along the longest dimension of the robot 14 or any other suitable dimension) corresponding to each antenna 28 (e.g., a first pitch corresponding to a first antenna, a second pitch corresponding to a second antenna, and so on). The “pitch” may indicate a slight tilt of the robot 14 corresponding to whether the robot 14 may be upright or in some other relative orientation. In some embodiments, the memory 34 (FIG. 2) of the robot 14 may store position information associated with each antenna 28, such as a distance between one or more of the antennas 28 and/or a position of each antenna 28 on the robot 14.

In operation, the processor 32 (FIG. 2) may receive the signals 110 from each transceiver 42 of the robot 14 and determine the time-of-flight measurements (e.g., data indicating a time corresponding to receipt of the signals 110) for each of the antenna 28. It should be noted that although five antenna 28 and one transceiver 42 are shown, the robot 14 may include any number of antenna 28 and/or transceivers 42. For example, the robot 14 may include 2, 3, 4, 5, 6, 7 or more antennas 28 and 1, 2, 3, 4, 5, 6, or more than 6 transceivers 42. That is, the robot 14 may include multiple transceivers 42, but less than the number of antennas 28. As such, more than one antenna, but less than the total number of antennas may be operated at a given time by the transceivers 42. It should be noted that including fewer antennas 28 and/or fewer transceivers 42 may reduce the cost of the robot 14, as well as utilize less computational resources by the processor 32.

Accordingly, the maneuver controller 30 may utilize position information 78 (FIGS. 3 and 4) and/or orientation information 80 (FIGS. 3 and 4) determined based on the communication between the transceiver 58 of the maneuver controller 30 and the transceiver 42 of the robot 14 to adjust actions and/or action parameters (e.g., thereby generating updated actions and/or action parameters) associated with the maneuver. For example, the illustrated embodiment of FIG. 5 represents a robot 14 that completed a jump from an initial position 112 to an incorrect location 24, although it may have been desirable for the robot 14 to jump to the target location 18. In this illustrated embodiment, the robot 14 jumped too far (e.g., the actuators 38 (FIG. 2) controlling the jumping motion of the robot 14 provided a relatively high amount of force to the robot 14) by a distance 114. Accordingly, the maneuver controller 30 may determine to reduce the amount of force applied by the actuators 38 such that the robot 14 jumps closer to the target location 18 (e.g., reducing the distance 114 between the target location 18 and the incorrect location 24). In this way, the maneuver controller 30 may improve the accuracy of maneuvers executed by the robot 14.

In some embodiments, the maneuver controller 30 may determine whether the robot 14 executed the maneuver successfully based on the sensors 27. The illustrated embodiment of FIG. 5 shows example locations for the sensors 27, such as on one or more surfaces of the robot 14, proximate to the target location 18, proximate to the incorrect location 24, or a combination thereof. Accordingly, the sensors 27 may be in suitable positions for determining whether the robot 14 landed in an incorrect location 24 or the target location 18 after executing a maneuver. Additionally or alternatively, the sensors 27 may be accelerometers that may measure an acceleration of the robot 14 as it executes an action. The acceleration measurements may be used to determine kinematic variables as described herein.

In some embodiments, the antennas 28 or sensors 27 may be disposed on one or more surfaces of the robot 14 and arranged in array. For example, the antennas 28 may be arranged in a linear, circular, or semi-irregular pattern on the one or more surfaces of the robot 14. It is recognized that placing the sensors 27 and/or antennas 28 in different positions may facilitate accurate detection of the position and/or orientation of the robot 14 by increasing the variability between each associated time-of-flight measurement.

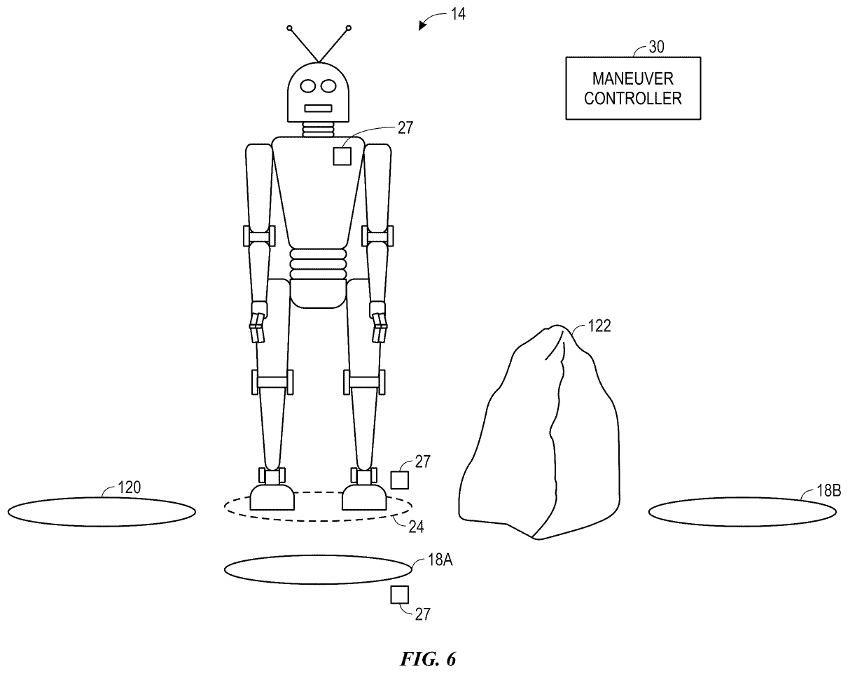

As described herein, the robot 14 may make multiple jumps and have multiple corresponding target locations 18. Following each jump, the location and orientation of the robot may be determined. If the robot 14 landed at an incorrect target location 24, then a corrected trajectory 26 (FIG. 1) may be determined (e.g., calculated) for the next jump. To illustrate this, FIG. 6 shows a schematic diagram of the robot 14 at the incorrect location 24 instead of the first target location 18a after performing a first jump from an initial location 120. The maneuver controller 30 may determine that the robot 14 is at the incorrect location 24 based on data acquired by the sensors 27. For example, the sensors 27 may transmit position information to the maneuver controller 30 indicating that the robot 14 is at the incorrect location 24. Additionally or alternatively, the sensors 27 may transmit orientation information to the maneuver controller 30 indicating a direction the robot 14 is facing. The maneuver controller 30 may determine an updated maneuver or action to perform as described with reference to block 84 of FIG. 3 or block 102 of FIG. 4. For example, the maneuver controller 30 may determine a turn for the robot 14 to perform such that the robot 14 is facing towards a second target location 18b while standing at the incorrect location 24. Further, the maneuver controller 30 may determine an updated jump to perform such that the robot 14 reaches the second target location 18b.

The maneuver controller 30 may determine that a feature 122 is between the incorrect location 24 (e.g., where the robot 14 is standing) and the second target location 18b. As such, the maneuver controller 30 may determine suitable action parameters (e.g., an amount of power to provide to the actuators 38 (FIG. 2), a magnitude of output (e.g., force, acceleration) to be provided by the actuators 38 (FIG. 2)) such that the robot 24 jumps over the feature 122. In some embodiments, the maneuver controller 30 may determine one or more additional maneuvers for the robot 14 to execute such that the robot 14 reaches the second target location 18b. For example, the maneuver controller 30 may determine a turn for the robot 14 to perform such that the robot 14 faces the first target location 18a and a jump to perform such that the robot 14 reaches the first target location 18a from the incorrect location 24. As another non-limiting example, the maneuver controller 30 may determine that the robot 14 should perform one or more steps away from the incorrect location 24 such that the robot 14 may reach the second target location 18b in a single jump.

As described herein, the maneuver controller 30 may utilize historical information to determine updated action parameters. As one non-limiting example, the maneuver controller 30 may determine a wind-speed and/or wind direction, which may have caused the robot 14 to jump to the incorrect location 24 as compared to the first target location 18a. As such, the maneuver controller 30 may adjust the direction the robot 14 jumps and/or the amount of power provided to the actuators 38 (FIG. 2) such that the robot 14 may reach the second target location 18b while being subjected to the wind speed and/or wind direction. In this way, the maneuver controller 30 may dynamically adjust maneuvers executed by the robot 14.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method for performing a robotic maneuver, the method comprising:
outputting, via one or more processors of a controller, instructions to at least a robot or an actuating device separate from the robot, wherein the instructions cause the robot to execute a maneuver;
obtaining, via the one or more processors of the controller, at least position information or orientation information for the robot subsequent to outputting the instructions;
determining, via the one or more processors of the controller, that the maneuver is executed unsuccessfully based on at least the position information or the orientation information; and
adjusting, via the one or more processors of the controller, operation of at least the robot or the actuating device separate from the robot based on the maneuver being executed unsuccessfully.

2. The method of claim 1, wherein obtaining, via the one or more processors of the controller, at least the position information or the orientation information, comprises:
receiving time-of-flight measurements; and
determining at least the position information or the orientation information based on the time-of-flight measurements.

3. The method of claim 1, wherein obtaining, via the one or more processors of the controller, at least the position information or the orientation information, comprises:
receiving position measurements acquired by a position sensor disposed on the robot; and
determining at least the position information or the orientation information based on the position measurements.

4. The method of claim 1, wherein obtaining, via the one or more processors of the controller, at least the position information or the orientation information, comprises:
receiving acceleration measurements acquired by an accelerometer disposed on the robot; and
determining at least the position information or the orientation information based on the acceleration measurements.

5. The method of claim 1, wherein the instructions to the robot to execute the maneuver comprise one or more action parameters.

6. The method of claim 1, wherein the maneuver comprises a performance of one or more actions to obtain a physical goal.

7. The method of claim 1, wherein the actuating device comprises a catapult, a ramp, a trampoline, a slingshot, or a combination thereof.

8. A system for performing a robot maneuver, the system comprising:
a robot body configured to be controlled by one or more actuators;
a plurality of antennas;
one or more transceivers coupled to the plurality of antennas; and
a processing system comprising one or more processors coupled to the one or more transceivers and the one or more actuators, the processing system configured to:
obtain an indication to execute a maneuver via the actuators;
determine an action to perform based on the maneuver;
transmit position information, orientation information, or both; and
perform the action associated with the maneuver.

9. The system of claim 8, wherein the position information, the orientation information, or both, comprises time-of-flight measurements.

10. The system of claim 8, wherein the plurality of antennas is disposed on the robot.

11. The system of claim 8, wherein the plurality of antennas is arranged in an internal surface of the robot body.

12. The system of claim 8, wherein the processing system is configured to determine the action by determining one or more action parameters.

13. The system of claim 8, wherein the processing system is configured to adjust operation of the robot by determining an additional action to perform based on the position information, the orientation information, or both.

14. A robot maneuver system, comprising:
a processing system comprising one or more processors, wherein the processing system is configured to:
transmit instructions to execute a maneuver to a robot, wherein the instructions are stored in memory accessible by the processing system;
transmit action parameters associated with the maneuver;
obtain at least position information or orientation information subsequent to transmitting the instructions to execute the maneuver;
determine updated action parameters based at least on the position information or the orientation information; and
adjust operation of the robot based on the updated action parameters.

15. The robot maneuver system of claim 14, wherein the action parameters comprise an amount of force to apply to one or more actuators of the robot.

16. The robot maneuver system of claim 14, comprising an antenna, wherein the processing system is configured to:
transmit signals to one or more antennas of the robot via the antenna; and
determine time-of-flight measurements based on the signals,
wherein the one or more processors are configured to obtain the position information, or the orientation information, or both, based on the time-of-flight measurements.

17. The robot maneuver system of claim 14, wherein the processing system is configured to determine the updated action parameters based on the position information, the orientation information, or both, by determining that a physical goal of the robot after performing the maneuver is outside of a threshold range.

18. The robot maneuver system of claim 14, wherein the processing system is configured to obtain the position information, wherein the position information comprises sensor measurements.

19. The robot maneuver system of claim 14, wherein the one or more processors are configured to determine an additional action for the robot to perform based on at least the position information or the orientation information.
